(19) United States
(12) Patent Application Publication
(10) Pub. No.: US 2026/0014718 A1
(43) Pub. Date: Jan. 15, 2026

(54) DOUBLE-HEADED RAZOR BLADE ASSEMBLY

(71) Applicant: Robbie Dupin, Vine Grove, KY (US)

(72) Inventor: Robbie Dupin, Vine Grove, KY (US)

(21) Appl. No.: 19/259,303

(22) Filed: Jul. 3, 2025

Related U.S. Application Data
(60) Provisional application No. 63/671,194, filed on Jul. 13, 2024.

(51) Int. Cl. B26B 21/52; B26B 21/22

(52) U.S. Cl. CPC B26B 21/521; B26B 21/222

(57) ABSTRACT

A double-headed razor blade assembly, including a handle, a blade head attachment portion connected to the handle, the blade head attachment portion including a plurality of first razor blade head receiving members, and a plurality of second razor blade head receiving members, a first razor blade head, including a first razor blade head main body, a plurality of first razor blades disposed within the first razor blade head main body, and a plurality of first razor blade head attachment members configured to removably attach to the plurality of first razor blade head receiving members, and a second razor blade head, including a second razor blade head main body, a plurality of second razor blades disposed within the second razor blade head main body, and a plurality of second razor blade head attachment members configured to removably attach to the plurality of second razor blade head receiving members.

### CROSS-REFERENCE TO RELATED APPLICATIONS

This application claims priority under 35 USC §120 from U.S. Provisional Application No. 63/671,194, entitled “DOUBLE-HEADED RAZOR BLADE ASSEMBLY,” which was filed on Jul. 13, 2024, in the United States Patent and Trademark Office, the disclosure of which is incorporated herein in its entirety by reference.

### BACKGROUND

### 1. Field

The present general inventive concept relates generally to a razor blade, and particularly, to a double-headed razor blade assembly.

### 2. Description of the Related Art

One of the most common challenges with conventional razors is achieving consistent results as one attempts to shave both sides of their face.

More often than not, individuals will have to spend time trying not to nick themselves with an increasingly-dulling blade, or will be required to use multiple disposable razors for one task.

Also, it would be convenient to have a razor blade that is usable both by men and women.

Therefore, there is a need for an improved razor blade.

### SUMMARY

The present general inventive concept provides a double-headed razor blade assembly.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a double-headed razor blade assembly, including a handle, a blade head attachment portion connected to a top portion of the handle, the blade head attachment portion including a plurality of first razor blade head receiving members, and a plurality of second razor blade head receiving members, a first razor blade head, including a first razor blade head main body, a plurality of first razor blades disposed within the first razor blade head main body, and a plurality of first razor blade head attachment members configured to removably attach to the plurality of first razor blade head receiving members, and a second razor blade head, including a second razor blade head main body, a plurality of second razor blades disposed within the second razor blade head main body, and a plurality of second razor blade head attachment members configured to removably attach to the plurality of second razor blade head receiving members.

The blade head attachment portion may further include a plurality of stabilizing bars to connect the plurality of first razor blade head receiving members to the plurality of second razor blade head receiving members.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a side angled view of a double-headed razor blade assembly, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Double-Headed Razor Blade Assembly 100

First Razor Blade Head 110

First Razor Blade Head Main Body 111

First Razor Blades 112

First Razor Blade Head Release Button 113

First Razor Blade Head Attachment Members 114

Second Razor Blade Head 120

Second Razor Blade Head Main Body 121

Second Razor Blades 122

Second Razor Blade Head Release Button 123

Second Razor Blade Head Attachment Members 124

Blade Head Attachment Portion 130

First Razor Blade Head Receiving Members 131

Second Razor Blade Head Receiving Members 132

Stabilizing Bars 133

Handle 140

Handle Main Body 141

Battery Cover 142

Battery 143

Vibrating Motor 144

Button 145

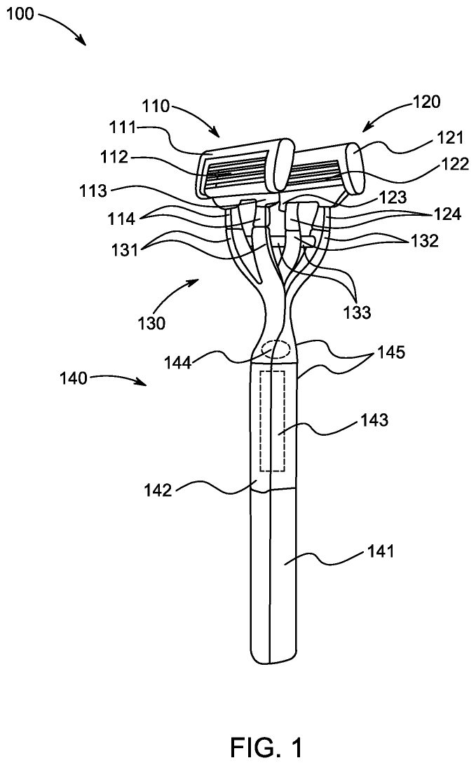

FIG. 1 illustrates a side angled view of a double-headed razor blade assembly 100, according to an exemplary embodiment of the present general inventive concept.

The double-headed razor blade assembly 100 and all components therein may be constructed from an elastic material, a waterproof material, plastic, metal, wood, silicone, rubber, liquids, or any other material known to one of ordinary skill in the art.

Referring to FIG. 1, the double-headed razor blade assembly 100 may include a first razor blade head 110, a second razor blade head 120, a blade head attachment portion 130, and a handle 140, but is not limited thereto.

The first razor blade head 110 may include a first razor blade head main body 111, a plurality of first razor blades 112, a first razor blade head release button 113, and a plurality of first razor blade head attachment members 114, but is not limited thereto.

The plurality of first razor blades 112 may be disposed within the first razor blade head main body 111 to allow a user to shave.

The second razor blade head 120 may include a second razor blade head main body 121, a plurality of second razor blades 122, a second razor blade head release button 123, and a plurality of second razor blade head attachment members 124, but is not limited thereto.

The blade head attachment portion 130 may include a plurality of first razor blade head receiving members 131, a plurality of second razor blade head receiving members 132, and a stabilizing bar 133, but is not limited thereto.

The plurality of first razor blade head receiving members 131 may correspond to and receive the plurality of first razor blade head attachment members 114 therein, in order to connect the first razor blade head 110 to the blade head attachment portion 130.

The plurality of second razor blade head receiving members 132 may correspond to and receive the plurality of second razor blade head attachment members 124 therein, in order to connect the second razor blade head 120 to the blade head attachment portion 130.

The first razor blade head release button 113 may be pressed to release the first razor blade head 110 from the blade head attachment portion 130. Specifically, when the first razor blade head release button 113 is pressed, the plurality of first razor blade head attachment members 114 may release from the plurality of first razor blade head receiving members 131, thus allowing the first razor blade head 110 to be removed from the blade head attachment portion 130.

The second razor blade head release button 123 may be pressed to release the second razor blade head 120 from the blade head attachment portion 130. Specifically, when the second razor blade head release button 123 is pressed, the plurality of second razor blade head attachment members 124 may release from the plurality of second razor blade head receiving members 132, thus allowing the second razor blade head 120 to be removed from the blade head attachment portion 130.

The stabilizing bars 133 may connect the plurality of first razor blade head receiving members 131 to the plurality of second razor blade head receiving members 132.

The blade head attachment portion 130 may be connected to the handle 140, or alternatively, may be detachable therefrom.

The handle 140 may include a handle main body 141, a battery cover 142, a battery 143, a vibrating motor 144, and a button 145, but is not limited thereto.

The handle main body 141 may include the battery cover 142 disposed on a surface thereof to allow a user to access an inner portion of the handle main body 141 when the battery cover 142 is removed, such that a user may install therein or remove therefrom the battery 143.

The vibrating motor 144 may be connected to the battery 143.

The button 145 may be disposed on a surface of the handle main body 141, and may provide an electric connection between the battery 143 and the vibrating motor 144 when the button 145 is pressed. In other words, when the button 145 is pressed, the vibrating motor 144 vibrates, and the vibrations are transferred to the first razor blade head 110 and the second razor blade head 120 to allow for a smoother shaving experience for the user.

A main purpose of the present general inventive concept is to provide users with a dual-headed disposable razor that allows for a quicker and smoother shaving experience. Ingenious and practical, the present general inventive concept offers an improved alternative razor option that provides a seamless shaving experience with consistent results on both sides of the face, by use of one primary razor. Expanding on the initial design of a disposable razor, the present general inventive concept introduces a novel two-razor head design that is attached to a single handle. Each razor head is engineered for optimal shaving performance, ensuring a close and comfortable shave with every use. By utilizing one razor head for each side of the face, users can maintain a balanced shave with uniformity and precision, without wasting precious time on managing a shave with various disposable razors. With the ability to choose the number of blades per side, individuals can achieve their desired level of closeness and smoothness without compromising on comfort. This innovative, top-quality product may benefit all individuals who seek to have a quicker, more convenient, and clean shaving experience and therefore may prove to be essential in the beauty/cosmetics industry.

The present general inventive concept is the only product of its kind that combines the convenience of a disposable razor with the precision of a double-headed design. This unprecedented product uniquely provides a single-blade, double-blade, triple-blade, or even quadruple-blade option, offering users customizable blade selections to suit individual shaving needs. Moreover, the present general inventive concept is carefully crafted with durable, high-quality materials to ensure pristine functionality.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A double-headed razor blade assembly, comprising:
a handle;
a blade head attachment portion connected to a top portion of the handle, the blade head attachment portion comprising:
a plurality of first razor blade head receiving members, and
a plurality of second razor blade head receiving members;
a first razor blade head, comprising:
a first razor blade head main body,
a plurality of first razor blades disposed within the first razor blade head main body, and
a plurality of first razor blade head attachment members configured to removably attach to the plurality of first razor blade head receiving members; and
a second razor blade head, comprising:
a second razor blade head main body,
a plurality of second razor blades disposed within the second razor blade head main body, and
a plurality of second razor blade head attachment members configured to removably attach to the plurality of second razor blade head receiving members.

2. The double-headed razor blade assembly, wherein the blade head attachment portion further comprises:
a plurality of stabilizing bars to connect the plurality of first razor blade head receiving members to the plurality of second razor blade head receiving members.
